(19) United States
(12) Patent Application Publication
(10) Pub. No.: US 2009/0044736 A1
(43) Pub. Date: Feb. 19, 2009

(54) Portable Safe For Temporary Non-Marring Attachment

(75) Inventors: Stephen W. Huber, Bettendorf, IA (US); Steven Kent Barton, Penrose, CO (US)

Correspondence Address: LATHROP & GAGE LC, 2345 GRAND AVENUE, SUITE 2800, KANSAS CITY, MO, 64108, US

(73) Assignee: TWIN STATE DESIGN PRODUCTS LLC, Davenport, IA (US)

(21) Appl. No.: 11/837,759

(22) Filed: Aug. 13, 2007

(51) Int. Cl. E05G 1/00

(52) U.S. Cl. 109/51

(57) ABSTRACT

A lockable storage box and mounting system for attachment to an object has an adjustable clamp bar having a flat surface and preferably an angle of diagonal orientation, apparatus for adjustably securing the clamp bar to the box forming a space between a first and a second flat, parallel, surface for engagement around the object.

### FIELD

A lockable storage box has apparatus for temporary, non-marring, attachment to dormitory furniture.

### BACKGROUND

Today's college students frequently have many portable, high-value, lightweight, items such as laptop computers, Personal Digital Assistant (PDAs), Apple IPOD® players, cell phones, MP3 players, and prescription drugs as well as wallets, cash and credit cards. These students typically live with roommates, and socialize, in small rooms with few, if any, hiding places. Often, many of these small rooms line long hallways with shared bathroom, kitchen, eating, and shower facilities ‘down the hall’ in a dormitory. As a result, many opportunities exist for casual theft of these small, high-value, items.

College students living in these dormitories, especially those who have already had small, high-value, items ‘disappear,’ often desire a lockable storage box, safe, or drawer for these high-value items.

Even in the rare cases where dormitory rooms have lockable drawers in desks, keys to these drawers have often been lost, or copies retained by, prior occupants of the rooms.

Portable lockable storage boxes or safes are almost as attractive to thieves as the small, high-value items that they may contain. Thieves steal portable safes, taking them to open at their leisure.

It is therefore desirable to attach portable safes to larger objects, such as furniture, that are not easily removed from a room without causing a disturbance.

Most furniture in typical dormitory rooms is not owned by the students. Walls and furniture in dormitory rooms are often required to be returned to their original condition and they are often inspected for damage when students check out of rooms at the end of term. It is therefore desirable to attach a portable safe to furniture in a non-marring manner.

Many dormitory rooms have bunk-beds. These are often made of wood or metal, having upright posts at the corners. While beds in a particular dormitory may be of the same design, having posts of similar thickness, there may be considerable variation in post thickness between beds in different dormitories. There may be other furniture in a room, such as bookcases or desks that may have upright posts or horizontal beams of varying thicknesses.

Outside of the dormitory situation, there is a need for lockable boxes in homes, rental facilities, temporary lodgings, offices, cars, trucks and other locations where persons having valuables need to have a place to place them for safekeeping while they are not on the premises or when they are outside their specific work or lodging areas.

Portable lockable boxes with apparatus for securing them to larger objects are known in the art. U.S. Pat. No. 4,649,723 describes a lockable box with a shackle. The shackle is, however, not adjustable. As it is not adjustable, it will fit only a limited range of furniture. Further, as it does not firmly attach to furniture, it will wiggle and thereby may mar finish of the furniture.

U.S. Pat. No. 4,474,116 describes a lockable box with a chain for securing it to furniture or other objects. U.S. Patent publication 2004-045329 describes a lockable box with a non-adjustable cable for securing it to furniture, as does U.S. Pat. No. 4,667,491.

U.S. Pat. No. 5,738,020 describes a lockable box having a mounting plate with screw holes for attachment to an object using screws driven into the object. Use of his device requires damage to the object.

### SUMMARY

A lockable storage box and mounting system for attachment to an object has an adjustable clamp bar having a flat surface, apparatus for adjustably securing the clamp bar to the box forming a space between a first and a second flat, parallel, surface for engagement around the object. The angle of the diagonal orientation of the clamp bar provides additional security by holding the box uniformly, allows the box to be mounted in numerous positions, and maximizes the allowable size of the object that the safe attaches to.

### BRIEF DESCRIPTION OF THE DRAWINGS

FIG. 1 illustrates a lockable storage box clamped to an upright wooden post, such as one of the corner posts of a bunk bed.

FIG. 2 is a frontal view of the lockable storage box of FIG. 1.

FIG. 3 is a side view of the lockable storage box of FIG. 1.

FIG. 4 is a view of an alternative embodiment of the lockable storage box.

FIG. 5 is a view of the embodiment of FIG. 4 with the bracket separated from the clamp bar.

FIG. 6 is a view of the embodiment of FIG. 4 with the components of the bracket separated.

FIG. 7 is a side view of an alternative embodiment secured to a post using a wedge.

FIG. 8 is a top view of the embodiment of FIG. 7.

FIG. 9 is a side cutaway view of the embodiment of FIGS. 7 and 8, taken along the line A-A in FIG. 8.

FIG. 10 is an exploded version of the cutaway view of FIGS. 9, showing the ramp and wedge.

FIG. 11 is a left-side view of the wedge of the embodiment of FIG. 7.

FIG. 12 is a left-side view of the bracket of the embodiment of FIG. 7.

FIG. 13 is a left-side view of the bracket and wedge of the embodiment of FIG. 7, with no post present and the bracket

FIG. 14 is an exploded perspective view of an alternative embodiment resembling that of FIGS. 1-3, attaching the clamp bar to a bracket which is then attached to the lockable storage box.

FIG. 15 is a schematic view of an alternative embodiment wherein the lockable storage attaches to a mounting bracket, wherein the clamp bar is attached to the bracket in manner resembling the way the clamp bar attaches to the storage box in FIG. 4.

### DETAILED DESCRIPTION OF THE EMBODIMENTS

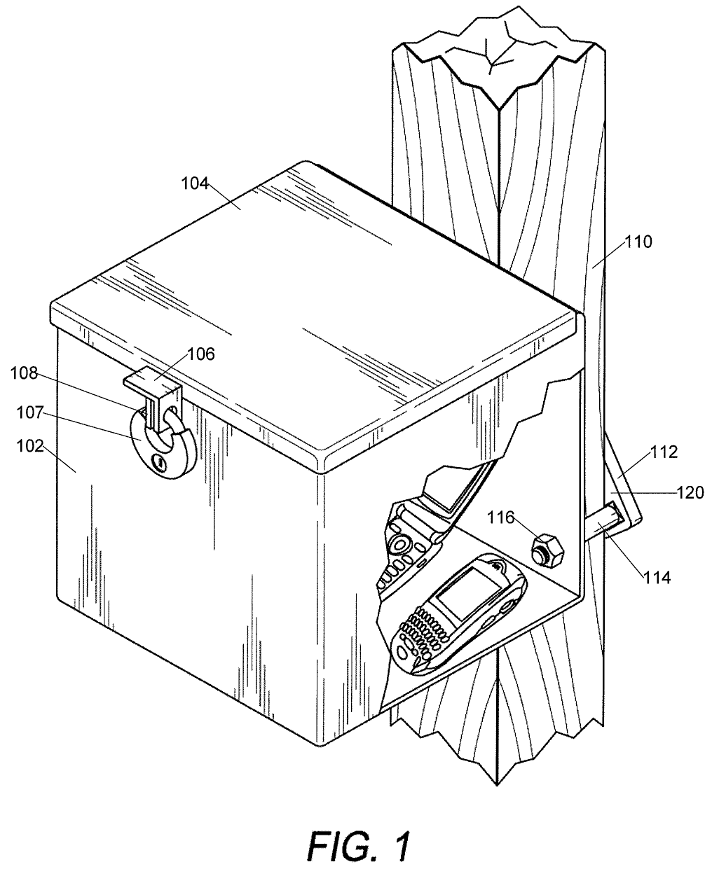

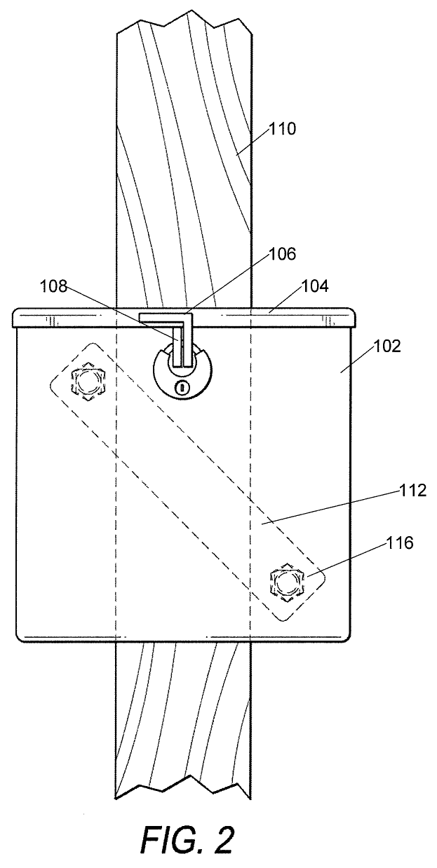

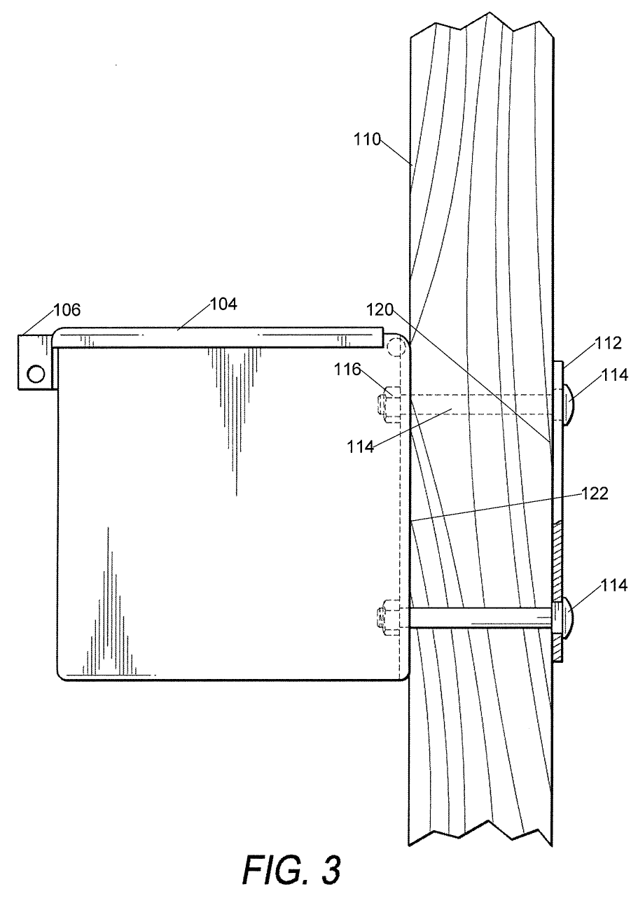

In an embodiment, as illustrated in FIGS. 1, 2, and 3, a storage box 102 has a hinged lid 104. The lid has a hasp 106 that may be locked by a padlock 107 to a mating hasp 108 on the box 102. In an alternative embodiment, a lock is included in the storage box body 102. The box is rigidly secured to a post 110, such as a vertical corner post of a bunk bed by a diagonal clamp bar 112, two carriage bolts 114, and two nuts 116.

The diagonal clamp bar 112 has a flat inward surface 120, and the box a flat rear surface 122, forming a space of therebetween, such that the post 110 may be clamped between these surfaces 120, 122, within the space without damaging the post 110. The diagonal clamp bar 112 is on a diagonal to provide additional security by holding the box 102 uniformly to the furniture or other object to which the box 102 is secured, thus preventing an intruder or thief from levering the box 102 and clamp bar 112 up and down to remove it from the furniture or other object to which the box 102 is attached.

In addition, the angle of the diagonal orientation allows the maximum possible space to allow the lockable box 102 to be attached to the largest possible object or piece of furniture.

In addition, it will be noted that the lockable box 102 may be mounted in numerous positions around an object such as a leg, bed post, or other suitably shaped object. For example, it may be mounted with the lid 104 on one side or the other of the object to which is mounted, with the lid 104 facing up, with the lid 104 facing down, or with the lid 104 facing one of the four sides of the object to which it is mounted. The box may also be mounted with the lid 104 at an angle with respect to the sides of the object, post, or leg to which it is mounted.

The embodiment of FIGS. 1, 2, and 3, may be provided with an assortment of sizes of carriage bolts 114 in half inch length increments or custom lengths to permit attaching the storage box 102 to posts 110 or horizontal bars (not shown) of varying thicknesses by adjusting a width of the space between the flat, parallel, rear surface 122 of the box 102 and the clamp bar 112. The carriage bolts have a square projection on the shaft side of their head that engages a square cutout in the diagonal clamp bar 112 to prevent the bolts 114 from turning while the nuts 116 are tightened. Nuts 116 are installed from the inside of the lockable storage box to help keep honest dorm-mates honest by making the nuts removable only from the inside of the box.

The storage box 102 may, of course, be made in a variety of shapes to accommodate laptop computers, notebooks, and other items. The lockable storage box 102 may be rectangular, flatter, cubed, square, and a variety of other shapes to accommodate such items. The clamp bar 112 and the rear surface 122 of the box 102 are preferably made smooth and flat so that they do not damage or mark the furniture or other objects to which they may be secured during the mounting or removal process.

As will be further noted, the clamp bar 112 can only be removed from inside the lockable storage box 102, thus locking the means of removing the box 102—i.e., the nuts 116—inside the box 102

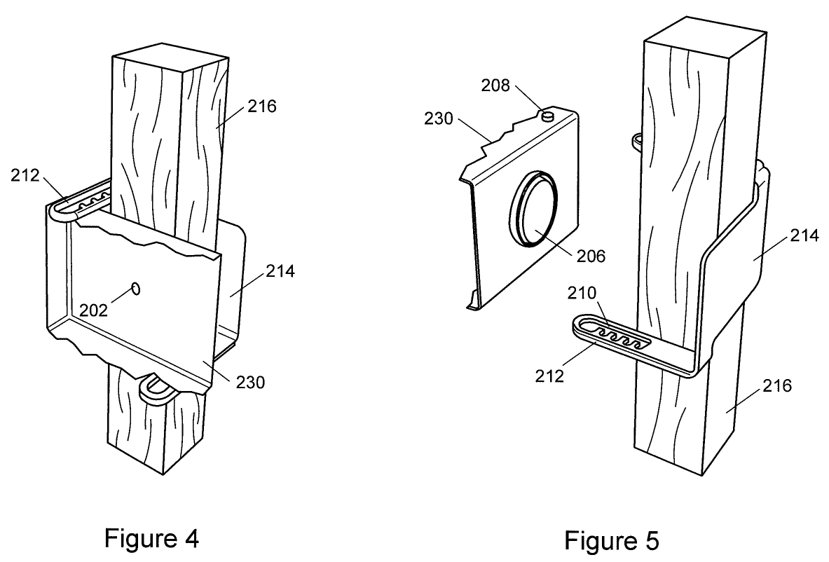

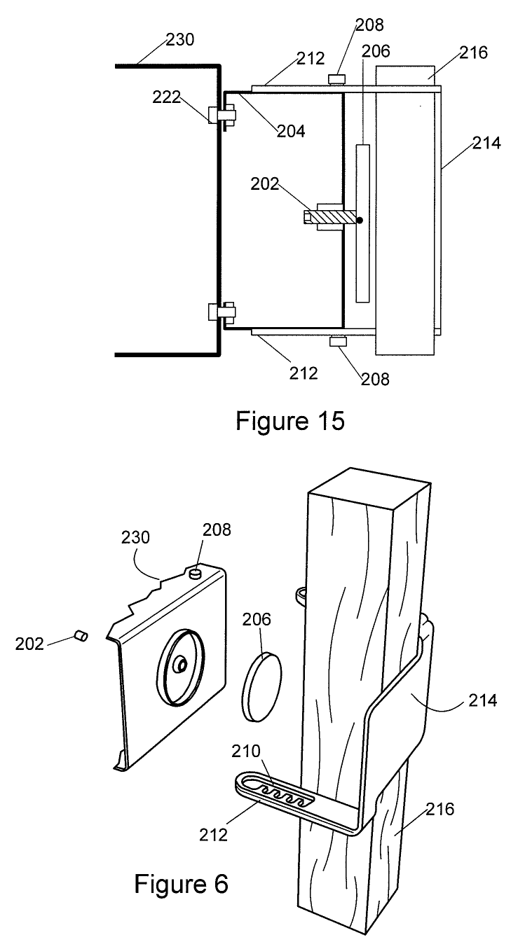

In the alternative embodiment of FIGS. 4, 5, and 6, the lockable storage box 230 is threaded for a screw 202 that mates to a plate 206. As screw 202 is tightened, screw 202 presses the plate 206 towards diagonal clamp bar 214. There is a rotatable joint, such as a ball joint, where screw 202 meets plate 206, allowing adjustment without marring furniture. The storage box 230 has two headed projections 208 welded to it. When the storage box 230 is installed on post 216, headed projections 208 are engaged with teeth 210 in a slot of attachment ear 212 of diagonal clamp bar 214. Since the attachment ear 210 has several teeth, diagonal clamp bar 214 may be installed in several positions relative to lockable storage box 230 to accommodate posts 216 of several thicknesses.

When the embodiment of FIGS. 4, 5, and 6 is installed, screw 202 is backed out as far as it will go, so that plate 206 is fully retracted. The diagonal clamp bar 214 is attached around the post 216, and headed projections 208 are engaged with teeth 210 of attachment ears 212 of the diagonal clamp bar 214. The screw 202 is then tightened, forcing plate 206 tightly against the post 216, stabilizing the box, and preventing disengagement of headed projections 208 from teeth 210.

With the embodiment of FIG. 4, an inner flat surface of clamp bar 214 and plate 206 form a space of adjustable width and flat parallel sides between the box 230 and clamp bar 214.

In an variation of this embodiment, as illustrated in FIG. 15, a bracket 204 is interposed between lockable box 230 and the post or bar 216 to which the box 230 is mounted. In this embodiment, projections 208 are welded to the bracket 204, instead of to the storage box 230. These projections are engaged with teeth 210 of attachment ear 212 of clamp bar 214 and space is filled by rotating screw 202 as heretofore described. The storage box 230 is then attached to bracket 204, with screws 222 preventing unauthorized persons from accessing screw 202.

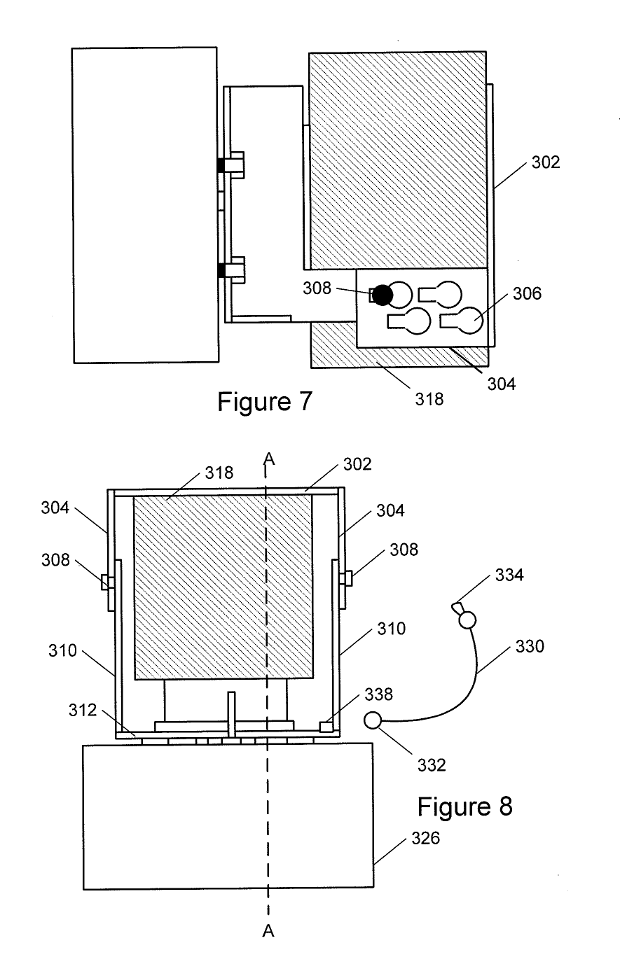

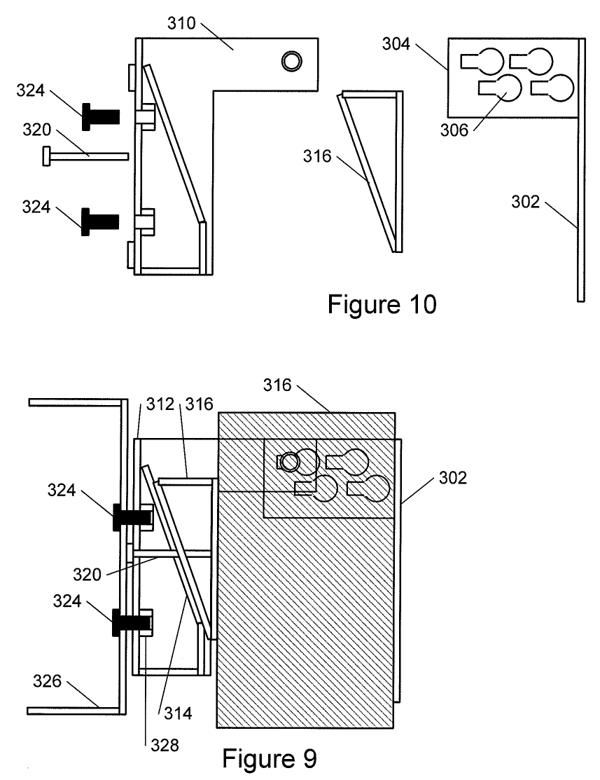

With the embodiment of FIGS. 7, 8, 9, 10, 11, 12, and 13 a diagonal clamp bar 302 has bracket attachment ears 304. Each ear 304 has several keyhole-shaped openings 306 sized to engage headed projections 308 welded onto clamp attachment bar 310 of a bracket 312. Bracket 312 has an integral ramp 314 that mates with a slideable wedge 316.

When the embodiment of FIG. 7 is installed to a post 318, the headed projections 308 are engaged into keyhole-shaped openings 306 in bracket attachment ears 304. The bracket 312 is then pulled away from the post to slide projections 308 into the narrow base of the keyhole-shaped openings 306. Next, the slideable wedge is inserted from the top of the bracket 312 to fill space between the bracket and the post 314.

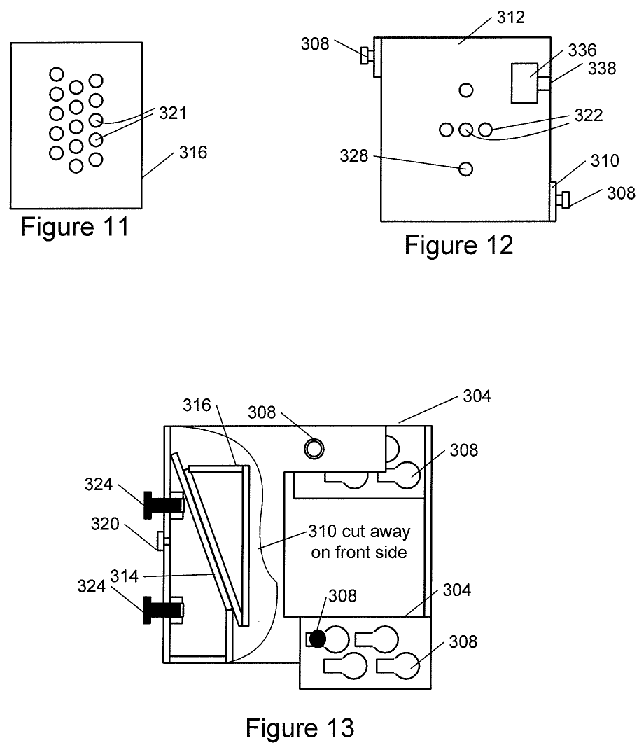

The wedge 316, as illustrated in FIG. 11, has a pattern of holes 321 in its hypotenuse. A pin 320, or a screw, is then inserted through a selected hole 322 (FIG. 12) in the base of the bracket, through a corresponding hole in the ramp 314 of the bracket, and through a hole 321 in the wedge to lock the wedge into place. The pattern of holes allows for extensive adjustment of wedge position.

Next, screws 324 are used to fasten the lockable storage box 326 into threaded screw holes 328, locking pin 320 in place. Screws 324 are accessible only from the interior of storage box 326, thereby deterring casual thieves from removing the box from the furniture.

With the embodiment of FIG. 7, a space of adjustable width is formed between the wedge.316 and clamp bar 302. Coarse width adjustment is performed by selecting appropriate keyhole-shaped openings 306, and fine width adjustment by sliding wedge 316. In an embodiment (not shown), twelve keyhole cutouts in three rows of four in a staggered pattern are provided providing coarse adjustment over a range of from one to four inches in quarter-inch steps.

To provide an alternative method of securing the embodiment of FIG. 7 to furniture where no suitable vertical post or horizontal bar is available, a cable 330 (FIG. 8) having a crimped-on fitting 332 at one end and a loop 334 at the other end. When this cable 332 must be used, the fitting 332 is passed around an object and through loop 334. The fitting is then placed in a cutout 336 (Figure) in bracket 312, and bracket 312 is attached to the lockable box 326 using the usual screws 324. Cable 330 is routed under dimple 338 that is stamp-formed in base of bracket 312 adjacent to cutout 336.

The lockable box of the embodiment of FIG. 7 has a hinged lid with hasps, permitting the lid to be locked closed using a standard padlock, or alternatively incorporating a lock built directly into the storage box.

In yet another alternative embodiment, not shown but similar to that of FIGS. 7-13, ramp 314 and ears 310 are welded directly to the lockable storage box 326 body, eliminating need for screws 324. In this embodiment pin or screw 320 is a screw that threadably engages in holes 322, which are drilled directly into the storage box 326. In this embodiment, the screw 320 can only be removed from within the lockable storage box 326, thereby preventing unauthorized persons from removing the wedge 316 and disengaging the headed projections 308 on ears 310 from keyhole-shaped openings 306.

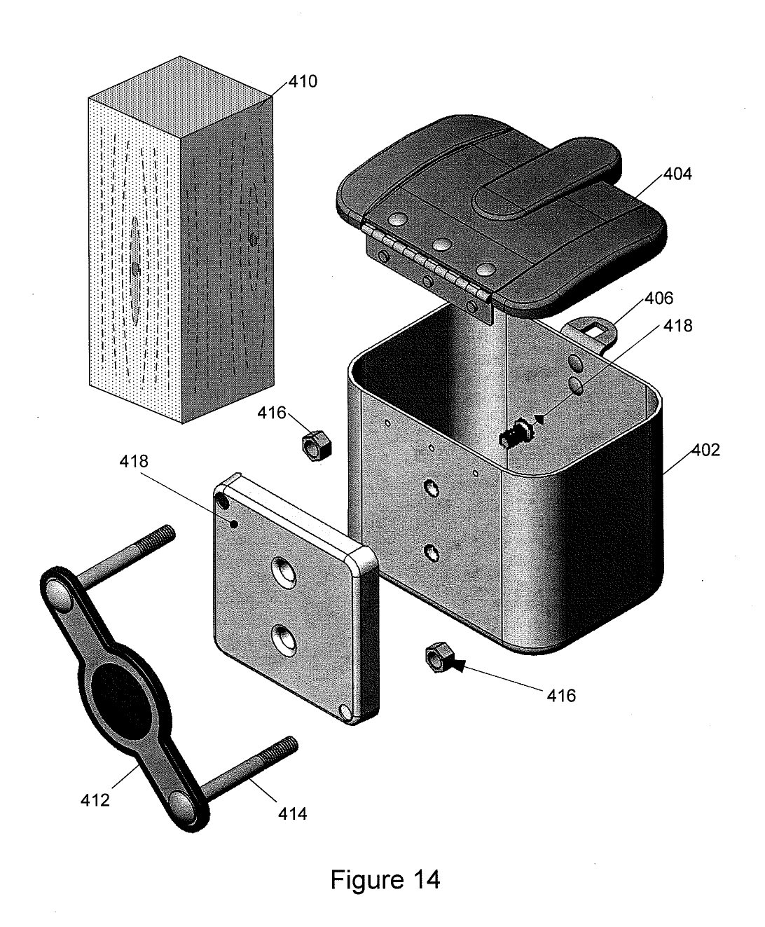

In the alternative embodiment of FIG. 14, a storage box 402 has a hinged lid 404. The lid has a hasp 406 that may be locked by a padlock (not shown) or alternatively a lock may be incorporated into the safe body 402. The box is rigidly secured to a post 410, such as a vertical post of a bunk bed by attaching a diagonal clamp bar 412,with two carriage bolts 414, and two nuts 416, to bracket 418. The storage box 402 is then attached to the bracket 418 with two screws 420

Clamp bar 302, 214, 112, 412 has a flat surface that faces towards the post or horizontal bar of the furniture to which the lockable storage box is attached. This surface is optionally covered with a layer of an elastomeric material to avoid marring the furniture. Similarly, the furniture surface of wedge 316, lockable box 122, and plate 206, may be coated with a layer of an elastomeric material.

Lockable storage box 102, 230, 402, 326, and lid 104, are preferably made of a sturdy material such as a heavy-gauge aluminum or steel. Similarly, the diagonal clamp bar 302, 214, 112, 412 and brackets 204, 312, and 418 are preferably also made of a reasonably sturdy material like aluminum or steel.

It is anticipated that the headed pins 208, 308 of the embodiments of FIGS. 4 and 7 may alternatively be welded to the clamp bar 214, 302, and their mating keyhole-shaped cutouts 306 and teeth 210 may be in mounting ears of the bracket 204, 312.

Each embodiment of the attachment system may be used with lockable storage boxes 326, 102, 402 of more than one shape. For example, a rectangular box about 10×14×4 inches in size may be used for securing laptop computers, while a smaller box about 7×7×7 inches in size may be used for securing wallets, cash, cell phones and PDAs.

The flat inner surfaces of clamp bar 112, 214, 302, 412 and the opposing flat surface of plate 206, wedge 316, or box 102, 122, 402 permit the lockable storage box to be secured to furniture, and removed therefrom, without marring the furniture.

The diagonal nature of clamp bar 112, 214, 302, 412 having 2 attachment points, not only permits the storage box to be attached to either a vertical post or a horizontal bar, but permits attaching the lockable storage box to furniture so that its hinged lid may face up or to either side. Further, the lockable storage box and clamping system may be assembled such that the box resides on any of the four sides of the post or horizontal bar, giving 12 possible mounting positions around a vertical post. The diagonal nature of the clamp bar also allows for the attachment to the maximum allowable dimension of post or horizontal bar. Finally, the diagonal nature of the clamp bar 112, 214, 302, 412 increases stability of the box on the post relative to a horizontal bar of the same width.

As heretofore explained in reference to each embodiment, the spacing between clamp bar 112, 214, 302, 412 and the opposing flat surface of plate 206, wedge 316, or box 102, 122, 412 may be adjusted to allow attachment to posts or bars having a variety of dimensions.

In the embodiment of FIGS. 1, 2, and 3, the nuts 116, are accessible only from within the lockable storage box, while in the embodiment of FIGS. 4, 5, 6 the adjustment screw 202 is only accessible from within the lockable storage box. Similarly, in the embodiment of FIGS. 7, 8, 9, 10, 11, 12, and 13, the embodiment of FIG. 14, and the embodiment of FIG. 15, the heads of the screws securing the lockable storage box to the bracket are accessible only from within the lockable storage box; and in these embodiments the box must be removed from the bracket to gain access to adjustment screw 202, nuts 416, or pin 320. These features make the box removable from furniture only by unlocking and opening the box to gain access to these screws.

While the forgoing has been particularly shown and described with reference to particular embodiments thereof, it will be understood by those skilled in the art that various other changes in the form and details may be made without departing from the spirit and hereof. It is to be understood that various changes may be made in adapting the description to different embodiments without departing from the broader concepts disclosed herein and comprehended by the claims that follow.

What is claimed is:

1. (canceled)

2. The lockable storage box and mounting system of claim 13 wherein the apparatus for securing the clamp bar to the box comprises a pair of carriage bolts.

3. The lockable storage box and mounting system of claim 2 wherein the apparatus for securing the clamp bar to the box further comprises a bracket.

4. The lockable storage box and mounting system of claim 5 wherein the clamp bar is attached at an angle of diagonal orientation with respect to the storage box.

5. The lockable storage box and mounting system of claim 13 wherein the apparatus for securing the clamp bar to the box comprises a first attachment apparatus for adjustably engaging second attachment apparatus of the clamp bar, and apparatus for adjustably filling space between the object and a member selected from the group consisting of a bracket and the lockable storage box.

6. The lockable storage box and mounting system of claim 12 wherein the apparatus for adjustably filling space comprises a wedge.

7. The lockable storage box and mounting system of claim 12 wherein the apparatus for adjustably filling space further comprises a device selected from the group consisting of a pin and a screw for locking the wedge into position.

8. The lockable storage box and mounting system of claim 12 wherein the apparatus for adjustably filling space comprises a screw for pressing against a plate.

9. The lockable storage box and mounting system of claim 12 wherein an apparatus selected from the first attachment apparatus and the second attachment apparatus is a headed pin.

10. The lockable storage box and mounting system of claim 9 wherein an apparatus selected from the first attachment apparatus and the second attachment apparatus is an ear having a plurality of keyhole-shaped holes.

11. The lockable storage box and mounting system of claim 9 wherein an apparatus selected from the first attachment apparatus and the second attachment apparatus is an ear having a slot with a plurality of teeth.

12. A lockable storage box and mounting system for attachment to an object comprising:
a box;
a lid hinged to the box;
a clamp bar having a first flat surface;
apparatus for securing the clamp bar to the box, forming a space between a first flat surface and a second flat surface parallel to the first flat surface for engagement around the object;
wherein a width between the first and second flat surfaces is adjustable to allow securing the box to a variety of objects;
wherein the second flat surface is selected from the group consisting of a flat surface of the box and a flat surface of a bracket attached to the box; and
apparatus for adjustably filling space between the object and a member selected from the group consisting of a bracket and the lockable storage box;
wherein a width between the first and second flat surfaces is adjustable to allow securing the box to a variety of objects.

13. A lockable storage box and mounting system for attachment to an object comprising:
a box;
a lid hinged to the box;
a clamp bar having a first flat surface;
apparatus for securing the clamp bar to the box, forming a space between a first flat surface and a second flat surface parallel to the first flat surface for engagement around the object;
wherein a width between the first and second flat surfaces is adjustable to allow securing the box to a variety of objects;
wherein the second flat surface is selected from the group consisting of a flat surface of the box and a flat surface of a bracket attached to the box; and
wherein the clamp bar attaches to the box at a diagonal with respect to the box such that the box is attachable with lid facing up to an element of furniture selected from the group consisting of a vertical post and a horizontal bar.
